(19) United States
(12) Patent Application Publication
(10) Pub. No.: US 2022/0232840 A1
(43) Pub. Date: Jul. 28, 2022

(54) HOME BAKERY BREAD MIX

(71) Applicant: NISSHIN FOODS INC., Tokyo (JP)

(72) Inventors: Masato FUKUDA, Tokyo (JP); Aoi NODA, Tokyo (JP)

(73) Assignee: NISSHIN FOODS INC., Tokyo (JP)

(21) Appl. No.: 17/618,355

(22) PCT Filed: Jul. 31, 2020
(86) PCT No.: PCT/JP2020/029375

§ 371 Date: Dec. 10, 2021

(30) Foreign Application Priority Data
Aug. 1, 2019 (JP) 2019-142356

(51) Int. Cl. A21D 13/06; A21D 10/00

(52) U.S. Cl. CPC A21D 13/06; A21D 10/002

(57) ABSTRACT

There is provided a bread mix for household use, containing, relative to the total mass of the mix, at least 50 mass % of strong flour, 5 to 20 mass % of gluten, and 15 to 25 mass % of a resistant starch-containing material having a dietary fiber content of at least 70 mass %. The bread mix preferably further contains 0.001 to 0.1 mass % of an emulsifier. The bread mix is preferably for use in breadmaking by the straight dough method. The bread mix is preferably for use in breadmaking with a breadmaker.

### TECHNICAL FIELD

This invention relates to a bread mix enabling home breadmaking by the straight dough method or by the use of a breadmaker or bread machine to make bread having a reduced content of glucide (carbohydrates except dietary fiber) and yet having a good appearance and texture.

### BACKGROUND ART

People often buy and eat breads that are baked at bakeries or mass-produced in factories and sold in retail stores. Although bread can be made at home using an oven and the like, making a relatively small amount of bread consumed at home requires complicated preparations. Therefore, a breadmaker has been commercially available, which makes enough bread for several people to eat almost fully automatically. Breadmaking methods are divided into two broad categories: straight dough method, and sponge and dough method. The straight dough method involves mixing all of bread ingredients at once to prepare dough, which is allowed to ferment and baked, and produces bread with good flavor brought out of the ingredients. The sponge and dough method includes preparing sponge from part of the ingredients, allowing the sponge to ferment, combining the rest of the ingredients with the fermented sponge and mixing to prepare dough, followed by fermentation and baking. Bread made by the sponge and dough method is soft and moist. In general, the sponge and dough method is seldom used in homes but is used in factory production because it is time consuming. The straight dough method, on the other hand, is mainly used for breadmaking in homes or breadmaking using a breadmaker because the entire process can be completed in about 3 to 6 hours.

Health management by low-carb diets has recently been attracting attention. Glucides are one of the three major nutrients, along with proteins and lipids. Glucides after absorption in the body are partly converted to lipids, which are accumulated to contribute to an increase in body fat. Excess glucide intake leads to an increase of blood glucose level, which can be a diabetes risk factor. Wheat flour (hereinafter, also simply referred to as flour), which is indispensable for modern diet, contains approximately 80% of starches, a type of glucides, and accordingly there are sometimes cases in which wheat flour usage must be restricted. In recent years, there is a growing trend to incorporate carbohydrate (glucide) restriction into daily diet against a backdrop of growing health consciousness, and various proposals for glucide restriction therapy or diet have been made. Bread, which is made mainly from wheat flour, is no exception, so that the need for low-carb bread suited for glucide restriction has been increasing.

Known wheat flour food products claiming low carb include those obtained by replacing, in ordinary carbohydrate flour foods, their glucides by dietary fiber (hereinafter, also simply referred to as fiber), which is indigestible by human digestive enzymes. Examples of useful dietary fiber include resistant starches, resistant dextrin, and inulin. The problem is that addition of fiber to wheat flour foods with the aim of reducing the glucide content deteriorates the texture, taste, and flavor originally possessed by flour foods and damages the palatability as food. A variety of proposals have been made to solve this problem.

Patent literature 1 listed below discloses a breadmaking composition containing a food material having a resistant starch content of at least 40 mass %, gluten, and a food material derived from soybeans. Patent literature 2 discloses a wheat flour substitute for bakery foods which contains a swelling-controlled starch and a swelling control free starch, and it is also disclosed that the swelling-controlled starch is rich in dietary fiber. Patent literature 3 proposes a diet food containing a soluble dietary fiber powder composed mainly of inulin and 2 to 20 times the weight of an insoluble dietary fiber selected from wheat bran, rice bran, and soy pulp.

The inventors have studied on a bread mix for making bread with an increased fiber content at home by the straight dough method or by the use of a breadmaker. They have then encountered in their study a problem, and the problem is that adding fiber to a bread mix results in not only crumbly, unpalatable bread but also insufficient rise in volume only to provide bread that is small in size and hard to eat particularly when the bread is made by the straight dough method.

### CITATION LIST

### Patent Literature

Patent literature 1: JP 2017-23048A
Patent literature 2: US 2008095909A1
Patent literature 3: US 2009202674A1

### SUMMARY OF INVENTION

An object of the invention is to provide a bread mix for household use which contains dietary fiber and can be used in the same way as common breadmaking flour to make low-calorie low-carb bread with at least about 30% less glucides than ordinary breads at home by the straight dough method or by the use of a breadmaker.

The invention provides a bread mix for household use containing at least 50 mass % of strong flour, 5 to 20 mass % of gluten, and 15 to 25 mass % of a resistant starch (hereinafter also abbreviated as RS)-containing material having a dietary fiber content of at least 70 mass %.

### DESCRIPTION OF EMBODIMENTS

The bread mix for household use according to the invention contains at least 50 mass % of strong flour, 5 to 20 mass % of gluten, and 15 to 25 mass % of an RS-containing material having a dietary fiber content of at least 70 mass %.

As used herein, the term “strong flour” for use in the invention is intended to include strong flour made from hard wheat varieties, French flour (intermediate between strong and all-purpose flours), and mixtures of strong flour and French flour. The strong flour content of the bread mix of the invention is at least 50 mass %, preferably 55 to 72 mass %, more preferably 60 to 70 mass %, relative to the total mass (dry mass, hereinafter the same) of the mix. If the strong flour content is less than 50 mass %, the resulting bread will have a less moist texture and less melt-in-the-mouth but an increased crumbly texture.

preferably, the strong flour used in the invention is commonly available native flour. While modified flours, such as oiled or thermally modified flour, are also available, they are not recommended because they can cause insufficient yeast fermentation or insufficient rise.

The gluten used in the invention is a mixture of gliadins and glutenins, which are wheat proteins. Wheat gluten is obtained by mixing flour with water to prepare dough, washing thoroughly the dough under a stream of running water or in a large amount of water until starch is washed away to leave a mass of gluten. Gluten is also obtained on an industrial scale from the residue left after extracting starch from wheat flour. The gluten used in the invention may be prepared as described, or a commercially available product.

Note that gluten in flour is present in the form of a complex with starch and other components of wheat, and accordingly, the extracted gluten prepared as above and gluten present in flour are different in behavior in dough making process. Therefore, the content of the extracted gluten in the bread mix of the present invention is defined independently of the content of gluten present in flour.

The gluten content in the bread mix of the invention is 5 to 20 mass %, preferably 8 to 18 mass %, more preferably 12 to 16 mass %, relative to the total mass of the mix. If the gluten content in the mix is less than 5 mass %, the resulting bread tends to be less puffy and have a crumbly texture. If the gluten content exceeds 20 mass %, the resulting bread can have a hard texture.

The bread mix of the invention further contains an RS-containing material. The RS-containing material used in the invention is a foodstuff containing resistant starch as a main component, preferably in an amount of at least 75 mass %. An RS-containing material may further contain other components such as a digestible component, in addition to resistant starch, and the RS-containing material used in the invention can be such an RS-containing material including other components. The other components are usually impurities unavoidably incorporated during purification of resistant starch.

The resistant starch has resistance to the digestive action of digestive enzymes and is categorized as dietary fiber. As used herein, the term “dietary fiber” or simply “fiber” refers to a food ingredient indigestible by human digestive enzymes.

Starches are polymers composed of glucose units linked via an α(1,4) and an α(1,6) linkage. Starches of biological origin are generally degraded by digestive enzymes. However, starches partially or totally having a specific structure or chemically modified starches show resistance to digestive enzymes.

The RS-containing material that can be used in the invention has a fiber content of at least 70 mass %, preferably 75 mass % or higher. As used herein, the term “(dietary) fiber content” refers to a value determined by the enzymatic-gravimetric method based on AOAC Official Method 985.29 (Prosky method), and the dietary fiber content may be determined using a commercially available assay kit based on the Prosky method, e.g., a dietary fiber assay kit from Wako Pure Chemical Corp. The term “(dietary) fiber content” as used herein means the content of all the fiber contained in the RS-containing material. In other words, in order to exhibit the desired effects of the invention, i.e., to provide low-calorie low-carb bread, the RS-containing material used in the invention has a content of all the fiber inclusive of resistant starch of at least 70 mass %. Nevertheless, because the fiber present in the RS-containing material typically consists solely or for the most part of resistant starch, “a fiber content of at least 70 mass %” as described above may usually be rephrased as “a resistant starch content of at least 70 mass %”. For instance, when a commercially available resistant starch, which is described below, is used as the RS-containing material, it is acceptable to rephrase as above.

Resistant starch is generally classified into the following four types, RS1 to RS4.

RS1 is starch that is per se digestible but is physically inaccessible to digestive enzymes because it is protected by integument or the like. RS 1 is mostly found in, for example, whole grains, seeds, and legumes.

RS2 is granular native starch that is resistant to digestion due to a specific crystal structure of the grains, and examples thereof include potato starch that has undergone wet-heat treatment under a low moisture condition, and unripe banana starch. High amylose starch is also categorized in RS2 because of its high amylose (linear) content.

RS3 is starch that has resistance to digestion as a result of the change into a structure inaccessible to digestive enzymes due to retrogradation, including retrograded starch (β′-starch), which is obtained by once gelatinizing (pregelatinizing) starch through heating and then cooling.

RS4 is starch that has resistance to digestion as a result of a high degree of chemical modification, including highly crosslinked starch and etherified and/or esterified starch.

Any of resistant starches RS1, RS2, RS3, and RS4 may be used in the invention. It is preferred to use an RS-containing material containing resistant starch categorized as RS2 or RS4, particularly RS4 and having a fiber content of at least 70 mass %.

The resistant starch may be either native (unmodified) or modified. Nevertheless, most of RS-containing materials containing native resistant starch generally have a fiber content less than 30 mass % and are often unsuitable for use in the invention. On the other hand, an RS-containing material containing resistant starch RS2 and having undergone heat treatment, such as heat-moisture treatment, has an increased fiber content as a result of the heating and is therefore suited for use in the invention. For example, high amylose corn starch with an amylose content of 70 mass % has a fiber content of only about 20 mass % as it is native (before heating) but its fiber content increases to about 60 mass % through heat-moisture treatment.

Commercially available products may be used as an RS-containing material in the present invention. Examples of commercial products containing RS2 include Nisshoku Lodestar available from Nihon Shokuhin Kako Co., Ltd., High Maize 1043 from Japan NSC Corp., and Actistar 11700 from Cargill Japan Ltd. Examples of commercial products containing RS4 include Pine Starch RT from Matsutani Chemical Industry Co., Ltd., Novelose from Ingredion Inc., Fiber Gym RW from Matsutani Chemical Industry, and Actistar RT 75330 from Cargill Japan Ltd. While these products are generally sold as resistant starch, they all have a fiber content of 70 mass % or higher and correspond to the RS-containing material as referred to in the invention.

The content of the RS-containing material in the bread mix of the invention is 15 to 25 mass %, preferably 17 to 24 mass %, more preferably 19 to 32 mass %, relative to the total mass of the mix. If the content of the RS in the bread mix is lower than 15 mass %, the expected health functions of resistant starch, such as reduction in calorie and glucide, may not be fulfilled. If the content of the RS in the bread mix exceeds 25 mass %, the resulting bread tends to be less puffy and have a crumbly texture.

The bread mix of the invention may further contain an emulsifier in addition to the above-described ingredients, i.e., strong flour, gluten, and resistant starch. The bread mix that contains an emulsifier will be made into bread with enhanced fluffiness, improved melt-in-the-mouth, and a less crumbly texture. Any emulsifier usable in foods can be used in the invention, including lecithins, sucrose fatty acid esters, polyglycerol fatty acid esters, and glycerol fatty acid esters, and among these, lecithins and sucrose fatty acid esters are preferred. The emulsifier content in the bread mix of the invention is preferably 0.001 to 0.1 mass %, more preferably 0.001 to 0.02 mass %, even more preferably 0.002 to 0.01 mass %, relative to the total mass of the bread mix.

The bread mix of the invention may further contain other ingredients common in breadmaking as appropriate according to the desired qualities of intended types of bread. Examples of useful other ingredients include cereal flours other than strong flour, starches other than the resistant starch, sugars, fats and oils, dry milk, food colors, flavors, salt, leavening agents, dry egg powder, thickening agents, egg shell calcium, enzymes, taste improvers, and spices. The total content of the other ingredients in the bread mix is preferably up to about 30 mass %, more preferably up to about 20 mass %, relative to the total manner of the mix.

The bread mix of the invention is obtained by appropriately mixing the above-described ingredients. The form of the bread mix of the invention is not particularly limited, but the mix is usually in the form of powder or granule at ambient temperature and ambient pressure.

The bread mix of the invention is used to make breads. The term “breads” refers to foods made by baking, steaming, frying, or otherwise heating leavened dough. The types of breads to which the invention is applicable include, but are not limited to, pan loaves (e.g., Pullman loaves and round top loaves), rolls, pastries and sweet buns (e.g., with bean jam or custard filling), bread with prepared food (e.g., buns with curry filling), French bread, crescent rolls (croissant), Danish pastries, pizzas, and yeast-raised doughnuts.

The bread mix for household use of the invention can be used in the same manner as ordinary strong flour. Accordingly, the bread mix of the invention can be handled in the same way as ordinary strong flour in making the above enumerated various types of breads.

Breadmaking methods are largely classified into straight dough method and sponge and dough method. The bread mix of the invention is suited for breadmaking by the straight dough method. The straight dough is generally a process including mixing all the ingredients together to prepare dough, allowing the dough to ferment, and baking the resulting dough. The bread made by this method has the good flavor brought out of the ingredients. The straight dough method is suitable for breadmaking at home or by the use of a breadmaker because the entire process can be completed in about 3 to 6 hours. The use of the bread mix of the invention in breadmaking by the straight dough method enables easily making bread that is low-calorie and low-carb and yet good enough in texture and appearance even at home. Using the bread mix at home with the aid of a breadmaker will make it easier to make such bread. Any commercially available breadmaker can be used without any limitation.

The bread mix of the invention enables making bread having equal or higher quality with a lower glucide content than that made from usual strong flour. Therefore, it is best suited for low-carb diets, nutrition therapies, and weight-loss diets.

### EXAMPLES

The invention will now be illustrated in greater detail with reference to Examples, but it should be understood that the invention is not deemed to be limited thereto. Unless otherwise specified, all the percentages are by mass.

The ingredients used in Examples and Comparative Examples were as follows.
RS-containing material A: “Pine Starch RT”, from Matsutani Chemical Industry Co., Ltd.; fiber content: 75%
RS-containing material B: “Novelose”, from Ingredion Inc.; fiber content: 90%
Insoluble fiber (cellulose)-containing material: “Ceolus”, from Asahi Kasei Corp.; fiber content: 95%
Gluten: “SuperGlu”, from Nippon Colloid Co., Ltd.
Strong flour: “Camellia”, from Nisshin Foods, Inc.
Weak flour: “Flour”, from Nisshin Foods, Inc.
Emulsifier: lecithin “Basis LP-20”, from Nisshin Oillio Group, Ltd.; and sucrose fatty acid ester “Ryoto Sugar Ester”, from Mitsubishi-Chemical Foods Corp.
Tapioca starch: “Matsunolin M-22”, from Matsutani Chemical Ind., Co., Ltd.
Albumen powder: “Kanso Ranpaku R”, from Zen-noh Kewpie Egg-station Co., Ltd.

### Examples 1 to 20 and Comparative Examples 1 to 11

The ingredients of the formulation shown in Tables 1 through 4 were mixed by stirring to prepare bread mixes for household use.

### Test Example 1—Evaluation of Glucide Content

The glucide content of each of the bread mixes of Examples and Comparative Examples was obtained by calculation. Specifically, the glucide content data for the individual ingredients were taken from Standard Tables of Food Composition in Japan (2015), 7th rev. The glucide content of the strong flour used in Reference Example was defined as 100, and the glucide content of each of the bread mixes of Examples and Comparative Examples was expressed in percentage relatively thereto. The results are shown in Tables 1 to 4.

### Test Example 2—Making and Evaluation of Bread

Bread was made from each of the bread mixes of Examples and Comparative Examples using a breadmaker SD-BM103 from Panasonic Corp. in accordance with the following procedure.

In a bread pan, 250 g of the bread mix, 17 g of sugar, 5 g of salt, 6 g of skim milk powder, and 10 g of butter were placed at room temperature (about 20° C.), and finally 180 g of water at 15° C. was poured. Separately, 2.8 g of dry yeast was put in a yeast dispenser. A menu number for “pan loaf” (crust color: medium) was selected and the breadmaker was started.

After the baking completed, the loaf was removed from the pan. The height of the loaf was measured, and the appearance was evaluated according to the scoring criteria below. Bread making and evaluation of appearance were carried out in decaplicate (n=10) for each bread mix. The average score is shown in Tables 1 to 4.

Then, the loaf was divided in two, and a panel of ten members assessed the texture of the half according to the following scoring criteria. The average of the scores given by the ten members is shown in Tables 1 to 4.

The reference bread in the following scoring criteria refers to the bread separately made in Reference Example in the same manner as above, except that strong flour was used instead of the bread mix.

### Scoring Criteria for Evaluation of Appearance:

5: Very good. Having a height of 95% or more relative to that of the reference bread with a nicely rounded top.
4: Good. Having a height of 80% or more but less than 95% relative to that of the reference bread with a nicely rounded top.
3: Fair. Having a height of 60% or more but less than 80% relative to that of the reference bread with a slightly deformed top, but generally acceptable.
2: Poor. Having a height of less than 60% relative to that of the reference bread with a largely deformed top.
1: Very poor. Almost no rise compared to dough.

### Scoring Criteria for Evaluation of Texture:

5: Very good. Having the same flavor as the reference bread with good mouthfeel and melt-in-the-mouth properties.
4: Good. Having the same flavor as the reference bread, but slightly inferior in mouthfeel and melt-in-the-mouth properties.
3: Fair. Slightly inferior to the reference bread in flavor, mouthfeel, and melt-in-the-mouth, but generally acceptable.
2: Poor. Inferior to the reference bread in flavor, mouthfeel, and melt-in-the-mouth.
1: Very poor. Considerably inferior to the reference bread in flavor, mouthfeel, and melt-in-the-mouth.

TABLE 1

| Formulation | Example | | Comparative Example | | | | | Ref. |
|---|---|---|---|---|---|---|---|---|
| (%) | 1 | 2 | 1 | 2 | 3 | 4 | 5 | Example |
| RS-Containing | 22 | | | 22 | | | 22 | |
| Material A | | | | | | | | |
| RS-Containing | | 22 | | | | | | |
| Material B | | | | | | | | |
| Insoluble | | | | | 22 | | | |
| Fiber- | | | | | | | | |
| Containing | | | | | | | | |
| Material | | | | | | | | |
| Gluten | 15 | 15 | 15 | | 15 | 15 | 15 | |
| Strong Flour | 63 | 63 | 85 | 78 | 63 | 63 | | 100 |
| Weak Flour | | | | | | | 63 | |
| Tapioca | | | | | | 22 | | |
| Starch | | | | | | | | |
| Total | 100 | 100 | 100 | 100 | 100 | 100 | 100 | 100 |
| Glucide | 70 | 66 | 85 | 85 | 64 | 93 | 76 | 100 |
| Content (vs. | | | | | | | | |
| Reference | | | | | | | | |
| Bread; %) | | | | | | | | |
| Appearance | 4.4 | 4.3 | 4.3 | 2.8 | 2.5 | 4.2 | 1.9 | 5.0 |
| Texture | 4.4 | 4.1 | 2.9 | 2.4 | 2.0 | 4.1 | 2.9 | 5.0 |

The bread of Comparative Example 2, which was prepared with the same formulation as in Reference Example except for replacing part of the strong flour with the RS-containing material, was much inferior in appearance and texture to the reference bread. The bread of Comparative Example 1, which was prepared with the same formulation as in Reference Example except for replacing part of the strong flour with gluten, the texture deteriorated after all though the adverse influence on appearance was small. In contrast thereto, the bread of Example 1, for which a combination of the RS-containing material and gluten was used, maintained the appearance as of the reference bread on a sufficiently satisfactory level. Surprisingly, in Example 1, the texture, which degraded when in using either one of the RS-containing material and gluten, was also maintained on a sufficiently satisfactory level, and the glucide content was also reduced to 70%.

When cellulose, which is categorized in insoluble fiber as with resistance starch, is used in combination with gluten as in Comparative Example 3, both the appearance and texture degrade. This indicates that, amongst insoluble dietary fibers, resistant starch is suitable to be combined with gluten. When common starch in place of resistant starch is combined with gluten as in Comparative Example 4, the appearance and texture are satisfactory, but the glucide content cannot be reduced greatly. When resistant starch and gluten are combined with weak flour as in Comparative Example 5, the glucide content can be reduced, but the appearance and texture degrade considerably.

TABLE 2

| | | | | | | | Compara. | |
|---|---|---|---|---|---|---|---|---|
| Formulation | Example | | | | | | Example | |
| (%) | 3 | 4 | 5 | 6 | 7 | 8 | 6 | 7 |
| RS-Containing | 15 | 17 | 19 | 23 | 24 | 25 | 12 | 28 |
| Material A | | | | | | | | |
| Gluten | 15 | 15 | 15 | 15 | 15 | 15 | 15 | 15 |
| Strong Flour | 63 | 63 | 63 | 62 | 61 | 60 | 63 | 57 |
| Albumen | 7 | 5 | 3 | | | | 10 | |
| Powder | | | | | | | | |
| Total | 100 | 100 | 100 | 100 | 100 | 100 | 100 | 100 |
| Glucide | 68 | 69 | 69 | 70 | 69 | 68 | 67 | 66 |
| Content (vs. | | | | | | | | |
| Reference | | | | | | | | |
| Bread; %) | | | | | | | | |
| Appearance | 3.7 | 4.0 | 4.2 | 4.2 | 3.9 | 3.6 | 2.9 | 2.9 |
| Texture | 3.9 | 4.1 | 4.3 | 4.1 | 3.7 | 3.4 | 3.3 | 2.7 |

TABLE 3

| | | | | | | | Compara. | |
|---|---|---|---|---|---|---|---|---|
| Formulation | Example | | | | | | Example | |
| (%) | 9 | 10 | 11 | 12 | 13 | 14 | 8 | 9 |
| RS-Containing | 22 | 22 | 22 | 22 | 22 | 22 | 22 | 22 |
| Material A | | | | | | | | |
| Gluten | 5 | 8 | 12 | 16 | 18 | 20 | 3 | 23 |
| Strong Flour | 63 | 63 | 63 | 62 | 60 | 58 | 63 | 55 |
| Albumen | 10 | 7 | 3 | | | | 12 | |
| Powder | | | | | | | | |
| Total | 100 | 100 | 100 | 100 | 100 | 100 | 100 | 100 |
| Glucide | 70 | 70 | 70 | 69 | 67 | 65 | 70 | 62 |
| Content (vs. | | | | | | | | |
| Reference | | | | | | | | |
| Bread; %) | | | | | | | | |
| Appearance | 3.4 | 3.8 | 4.2 | 4.6 | 4.5 | 4.3 | 2.8 | 4.2 |
| Texture | 3.8 | 4.1 | 4.3 | 4.2 | 3.8 | 3.4 | 3.4 | 2.8 |

TABLE 4

| | | | | | | | Compara. | |
|---|---|---|---|---|---|---|---|---|
| Formulation | Example | | | | | | Example | |
| (%) | 15 | 16 | 17 | 18 | 19 | 20 | 10 | 11 |
| RS-Containing | 22 | 22 | 22 | 22 | 22 | 22 | 22 | 20 |
| Material A | | | | | | | | |
| Gluten | 15 | 15 | 15 | 10 | 8 | 6 | 15 | 5 |
| Strong Flour | 50 | 55 | 60 | 68 | 70 | 72 | 45 | 75 |
| Albumen | 13 | 8 | 3 | | | | 18 | |
| Powder | | | | | | | | |
| Total | 100 | 100 | 100 | 100 | 100 | 100 | 100 | 100 |
| Glucide | 57 | 62 | 67 | 75 | 77 | 79 | 52 | 82 |
| Content (vs. | | | | | | | | |
| Reference | | | | | | | | |
| Bread; %) | | | | | | | | |
| Appearance | 3.6 | 4.0 | 4.3 | 4.4 | 4.1 | 3.9 | 2.9 | 3.7 |
| Texture | 3.8 | 4.1 | 4.2 | 4.3 | 3.8 | 3.4 | 4.4 | 2.9 |

The breads made from the bread mixes of Examples achieved a glucide reduction of about 30% in most Examples (at least 20% in all Examples) as compared with the reference bread and yet maintained the appearance and texture on satisfactory levels. In contrast, the breads made from the bread mixes of Comparative Examples achieved no glucide reduction or were given low scores of appearance and/or texture.

In some of Examples 3 to 8 (Table 2), in which the content of the RS-containing material was varied, and Examples 9 to 14 (Table 3), in which the gluten content was varied, albumen powder, which has no influence on the bread evaluation, was used so that all the mixes might have approximately the same glucide content. In Examples 15 to 20 (Table 4), in which the strong flour content was varied while using the formulation of Example 1 as the base, the gluten was decreased when the strong flour was increased, or albumen powder was added when the strong flour was decreased.

### Examples 21 to 26

Bread mixes were prepared additionally using an emulsifier according to the formulations shown in Table 5. The glucide content of each mix was calculated in the same manner as in Test Example 1. Bread was made from each mix and evaluated for appearance and texture, in the same way as in Test Example 2. The results obtained are shown in Table 5, in which the results of Example 1 are also shown.

TABLE 5

| Formulation | Example | | | | | | |
|---|---|---|---|---|---|---|---|
| (%) | 1 | 21 | 22 | 23 | 24 | 25 | 26 |
| RS-Containing | 22 | 22 | 22 | 22 | 22 | 22 | 22 |
| Material A | | | | | | | |
| Gluten | 15 | 15 | 15 | 15 | 15 | 15 | 15 |
| Strong Flour | 63 | 62.998 | 62.99 | 62.98 | 62.998 | 62.99 | 62.98 |
| Lecithin | | 0.002 | 0.01 | 0.02 | | | |
| Sucrose Fatty | | | | | 0.002 | 0.01 | 0.02 |
| Acid Ester | | | | | | | |
| Total | 100 | 100 | 100 | 100 | 100 | 100 | 100 |
| Glucide | 70 | 70 | 70 | 70 | 70 | 70 | 70 |
| Content (vs. | | | | | | | |
| Reference | | | | | | | |
| Bread; %) | | | | | | | |
| Appearance | 4.4 | 4.7 | 4.8 | 4.7 | 4.7 | 4.7 | 4.6 |
| Texture | 4.4 | 4.6 | 4.7 | 4.6 | 4.6 | 4.6 | 4.6 |

### INDUSTRIAL APPLICABILITY

The invention provides a bread mix for household use which contains dietary fiber and can be used in the same way as common breadmaking flour to make low-calorie low-carb bread with at least about 30% less glucides than ordinary breads at home by the straight dough method or by the use of a breadmaker.

1. A bread mix for household use, comprising, relative to the total mass of the mix,
at least 50 mass % of strong flour,
5 to 20 mass % of gluten, and
15 to 25 mass % of a resistant starch-containing material having a dietary fiber content of at least 70 mass %.

2. The bread mix according to claim 1, further comprising 0.001 to 0.1 mass % of an emulsifier.

3. The bread mix according to claim 1, for use in breadmaking by the straight dough method.

4. The bread mix according to claim 1, for use in breadmaking with a breadmaker.
